(19) United States
(12) Patent Application Publication
(10) Pub. No.: US 2015/0300412 A1
(43) Pub. Date: Oct. 22, 2015

(54) RESOLVER BEARING

(71) Applicant: Schaeffler Technologies GmbH & Co.KG, Herzogenaurach (DE)

(72) Inventor: Joerg Kegeler, Schleusingen (DE)

(21) Appl. No.: 14/423,699

(22) PCT Filed: Sep. 4, 2013
(86) PCT No.: PCT/DE2013/200155

§ 371 Date: Feb. 24, 2015

(30) Foreign Application Priority Data
Sep. 10, 2012 (DE) 10 2012 215 957.6

(51) Int. Cl. F16C 41/00; F16C 19/06

(52) U.S. Cl. CPC F16C 41/007; F16C 19/06

(57) ABSTRACT

A compact resolver bearing constructed in a particularly simple manner is provided. The corresponding coils P, S are arranged in the annular chamber formed between the bearing rings, the annular chamber being sealed by two circular ring discs, each of said circular ring discs being non-rotatably mounted on another ring and extending radially in the direction of the other ring while maintaining a slight axial distance A from the respective other circular ring disc. In order to modulate the magnetic flux generated by the toroidal coil P1 in the bearing, the circular ring discs are each provided with a segment made from a magnetically permeable material. The changeable mutual overlapping of the segments during rotation causes the magnetic resistance of the corresponding magnetic circuit M1, M2 to change. Each magnetic circuit has two circular ring discs, toroidal coils that act as a primary coil and a secondary coil, each extending around the axis of rotation, the magnetically permeable bearing rings and a further component provided between the bearing rings and made from a magnetically permeable material.

The present invention relates to a so-called resolver bearing, i.e., a rolling bearing arrangement including an angle sensor or a rotational speed sensor.

### BACKGROUND

A generic arrangement, which includes a rolling bearing as well as an angle sensor referred to as a resolver and designed as an absolute encoder, is known, for example, from US 2006/0087315 A1. The angle sensor includes a stator, which is connected to the outer ring of the rolling bearing, as well as a rotor, which interacts with the stator, is designed as an eccentric ring and is formed by the inner ring of the rolling bearing.

Another rolling bearing, which is equipped with a sensor provided for detecting a rotation parameter, is known from EP 1 518 126 B1. In this case, transmitting microcoils and receiving microcoils of the sensor are situated on a carrier, namely a substrate of a printed circuit. A processing circuit, which includes an oscillator as well as phase demodulators, is furthermore situated on the carrier.

A resolver, which operates according to the principle of variable reluctance, is known from U.S. Pat. No. 7,135,860 B2, which includes a rotor having multiple detection areas, which is to be used, in particular, for reliable zero point detection.

A rolling bearing arrangement is known from WO 002011134955, which includes two one-part or multi-part bearing rings, concentric to its rotation axis, namely an inner ring and an outer ring, at least one series of rolling bodies being situated between the bearing rings. Furthermore, a toroidal sealing ring is present, which is connected to one of the bearing rings with one of its two edges and whose free edge extends radially in the direction of the other bearing ring and which seals a side of the annular space formed between the bearing rings, and in which the rolling bodies roll on tracks provided by the bearing rings. An angle sensor is coupled laterally on one of the front surfaces of the rolling bearing arrangement for the purpose of detecting the angular position of the first bearing ring relative to the second bearing ring. This angle sensor includes at least one etalon, which is rotatably fixedly connected to one of the two bearing rings, a transmitting coil, which is rotatably fixedly connected to the other of the two bearing rings, and at least one receiving coil, which is also rotatably fixedly connected to the other of the two bearing rings, a signal being transmittable between the transmitting coil and the receiving coil via a magnetic circuit, and a variable reluctance existing in the magnetic circuit, due to the etalon. Specifically, the magnetic circuit is provided in that the transmitting coil is situated in an annular pot core having a U-shaped cross section and is connected to one of the bearing rings via a series of adapters, and the etalon, which has an eccentric shape and is connected to the other bearing ring, essentially runs between the legs of the U-shaped cross section. The receiving coil or receiving coils is/are situated partially inside and partially outside the pot core.

If the etalon is connected to the inner ring, which is rotatable with respect to the outer ring, and if the inner ring is set into rotation, the likewise rotating, eccentric etalon overlaps another area of the annular, U-shaped cross section of the pot core, which is open in the direction of the etalon, at each point in time of a rotation around 360°, the mutual overlapping slowly increasing from a minimal partial overlapping surface to a maximum overlapping surface, due to the design of the etalon and the receiving coil or coils, to then decrease from the maximum overlapping surface to an overlapping of “zero.” Since the scope of the overlapping is moreover significant for the magnetic resistance, voltages of different levels are induced in the receiving coil or coils according to this resistance.

As is easily apparent, the structure of resolver bearings of this type is extremely complex, since a number of different parts must be provided for its implementation. In addition, it is deemed to be disadvantageous that the structural width of the rolling bearing arrangement is significantly increased in the direction of the rotation axis due to the connection of the rolling bearing arrangement and the angle sensor.

### SUMMARY OF THE INVENTION

It is an object of the present invention to provide a resolver bearing which has a very simple structure and occupies very little installation space.

If the bearing rings and a component provided between the bearing rings are made of a magnetically permeable material, an additional circular ring disk is situated next to the circular ring disk at a slight axial distance A, the additional circular ring disk being rotatably fixedly connected to the other ring and also extending radially in the direction of the ring, to which this additional circular ring disk is not connected. If each circular ring disk is provided with at least one segment 15.1, 15.2 made of a magnetically permeable material, and if particular coils P1, S1 in the annular space between the two circular ring disks and the component are rotatably fixedly connected to the rings, a resolver bearing of a very simple design is created without the coils having to assume a particular position in the so-called ferromagnetic circuit with respect to the segments causing the modulation of the magnetic flux.

Only for the sake of completeness, let it be noted at this point that the term magnetically permeable materials is understood to be materials which have a significantly weaker magnetic resistance than air. In particular, ferromagnetic materials, such as iron, ferrite or even plastic-bonded iron powder, come into consideration.

If the component connected to the rings is formed by the rolling bodies rolling on the tracks, the resolver bearing largely corresponds to a conventional bearing, so that components commonly used for conventional bearings may be completely resorted to form a resolver bearing. In addition, it is not necessary to dispense with the measuring function of resolver bearings if the rolling bodies appear to be unsuitable for closing the magnetic circuit. In this case, it is only necessary to provide so-called short circuit sheets, which extend from a rotatably fixed connection to one of the bearing rings in the direction of the other bearing ring and which are suitable for closing a magnetic circuit. The use of toroidal short circuit sheets also contributes to improving the sealing of the bearing, since an additional gap seal is established by these short circuit sheets. An adequate sealing of the resolver bearing exists-if the annular space between the rings is completely sealed against the environment by circular ring disks, in that in addition to the two existing circular ring disks, two additional circular ring disks situated at a slight axial distance A from each other are provided, each of these additional circular ring disks being rotatably fixedly connected to another ring and extending radially in the direction of the particular other ring.

In addition to sinusoidal signals, cosinusoidal signals may also be generated on a resolver bearing, if each of the additional circular ring disks is provided with at least one segment made of a magnetically permeable material, the segments of the additional circular ring disks are offset with respect to each other by an angle of 90°/n, n corresponding to the number of segments per circular ring disk, while the segments of the additional circular ring disks do not assume an angle offset with respect to the segments of the other circular ring disks in this position of the segments of the additional circular ring disks, another toroidal coil P2 and another secondary coil S2 are provided, and these coils P2, S2 are rotatably fixedly connected to the rings in the annular space between the additional circular ring disks and the rolling bodies and/or a short circuit sheet. It does not matter how the angle offset of the segments is ultimately implemented. For example, the segments of the circular ring disks, which are rotatably fixedly connected to the rotating bearing ring, may have an angle offset of 90°/n, while the segments of the two remaining circular ring disks, which are rotatably fixedly connected to the stationary bearing ring, fully overlap in the axial direction. Since the degree of overlapping of segments of two different circular ring disks forming a common seal alone is important, it does not matter later on if two circular ring disks forming a seal between themselves rotate by an identical angle with respect to the other annular disks forming the other seal once a single alignment in the aforementioned sense is carried out. Only for the sake of completeness, let it be noted that an alignment of the circular ring disks is particularly easy if complementary projections and grooves are provided on bearing rings and circular ring disks, which permit a connection between the particular circular ring disks and the corresponding bearing rings in only one relative position with respect to each other.

A particularly easy method of electrically contacting the coils is implemented if the coils are each connected to the stationary ring of the two rings.

Precise angle indications are provided with the resolver bearing, if each circular ring disk includes a plurality of segments which are situated evenly distributed in the circumferential direction of the circular ring disks.

The formation of circular ring disks is simplified if the circular ring disks are made of a material which has no or only a slight magnetic permeability and the segments are situated embedded in the circular ring disks. The formation of circular ring disks is particularly easy, for example, if the circular ring disks are manufactured from plastic and the segments have been embedded during the formation of the circular ring disks.

A particular ease of installation is provided, if either one of coils P, S, or a unit of two coils, which are connected with the modulation action of two circular ring disks, forms one structural unit together with one of the two circular ring disks, in that the corresponding circular ring disk is mounted and connected laterally to coil P or S or the unit of two coils, and the particular structural unit is inserted as such into the annular space and rotatably fixedly connected to the particular ring. In connection with this application, inserted is understood to be both the complete insertion and the incomplete insertion of the unit into the annular space.

### BRIEF DESCRIPTION OF THE DRAWING

FIG. 1 shows a sectional representation of a resolver bearing;

FIGS. 2a, 2b each show a side view of a resolver bearing according to FIG. 1;

FIG. 3 shows a detail of a seal;

FIG. 4 shows four circular ring disks; and

FIG. 5 shows a sectional representation of another resolver bearing.

### DETAILED DESCRIPTION

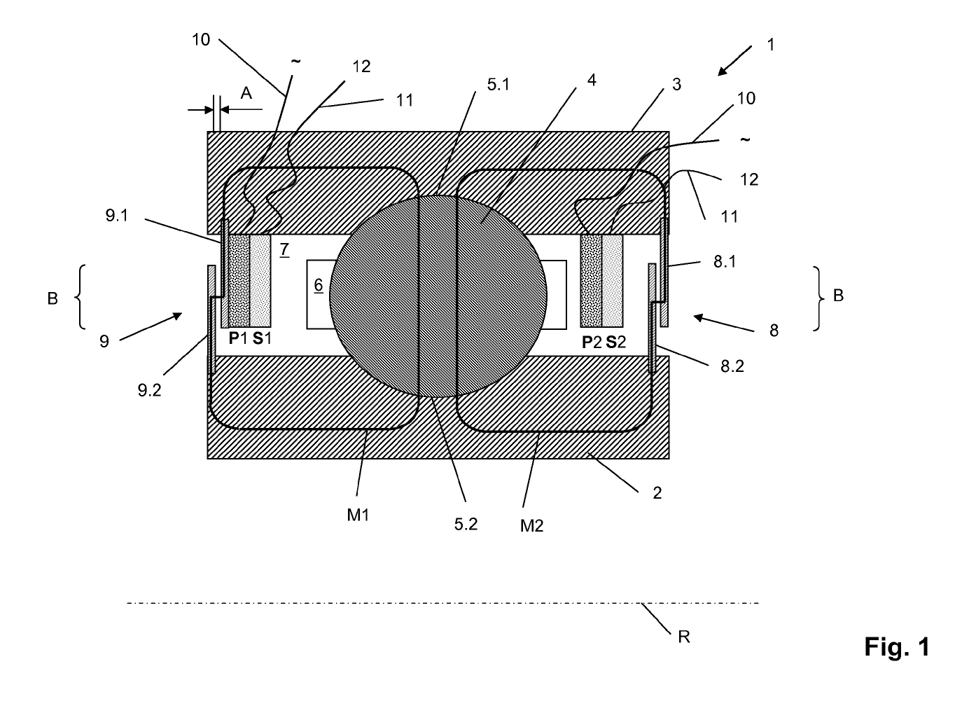

FIG. 1 shows a sectional representation of a resolver bearing 1 above rotation axis R. This resolver bearing 1 is formed by an inner ring 2, an outer ring 3 and rolling bodies 4, which roll on tracks 5.1, 5.2 provided by rings 2, 3. Rings 2, 3 and rolling bodies 4 are made of a magnetically permeable material. The exemplary embodiment according to FIG. 1 furthermore has a cage 6, which guides rolling bodies 4.

Annular space 7 between bearing rings 2, 3 is protected against environmental influences by seals 8, 9 in such a way that each of these seals 8, 9 is formed by a first circular ring disk 8.1, 9.1, which is rotatably fixedly connected to inner ring 2, and a circular ring disk 8.2, 9.2, which is likewise rotatably fixedly connected to outer ring 3. The diameters of the two circular ring disks 8.1, 8.2 and 9.1, 9.2 forming a seal 8 or 9 are selected in such a way that each of the two seals 8, 9 has an area B in which first circular ring disks 8.1, 9.1 partially cover second circular ring disks 8.2, 9.2, when viewing rolling bodies 4 along rotation axis R. In the exemplary embodiment illustrated in FIG. 1, this is achieved in such a way that circular ring disks 8.1, 9.1, which are connected to outer ring 3, extend only to inner ring 2 without touching it, while circular ring disks 8.2, 9.2, which are connected to inner ring 2, maintain a slight radial distance from outer ring 3. It is furthermore apparent from FIG. 1 that the two circular ring disks 8.1, 8.2 and 9.1, 9.2, which each form a seal 8, 9, maintain an axial distance A from each other, which forms a gap seal and is also referred to below as an air gap.

Furthermore, two toroidal coils P1, P2 are accommodated in annular space 7, which, in the exemplary embodiment illustrated in FIG. 1, are rotatably fixedly connected to stationary outer ring 2 and are energizable from an alternating current source˜via connecting lines 10. If the particularly easy type of contacting on stationary bearing ring 2 is dispensed with, one or even all toroidal coils P1, P2 may be rotatably fixedly connected to the rotating bearing ring of the two bearing rings 2 or 3 in another exemplary embodiment, which is not illustrated in greater detail. In this case, coils P1, P2 are to be contacted via slip rings, which are known to those skilled in the art. When toroidal coils P1, P2 are energized, two magnetic circuits M1 and M2 form, which are discussed in greater detail below.

A secondary coil S1, S2 is situated next to each of these two toroidal coils P1, P2 in the axial direction, toroidal coil P1 abutting secondary coil S1 and toroidal coil P2 abutting secondary coil S2 without spaces in the exemplary embodiment illustrated in FIG. 1. As is easily apparent, this lack of spacing has advantages during manufacturing and assembly, since the unit of ring and secondary coil P1, S2; P2, S2 may be prefabricated outside bearing 1 and be connected to particular bearing ring 2 (3) as a unit. If one makes use of this manufacturing and assembly advantage, secondary coils S1 and S2 may also maintain an axial distance from their particular toroidal coils P1, P2, provided that secondary coils S1, S2 remain situated within particular magnetic circuit M1, M2 of the components of the bearing which extend from toroidal coils P1, P2 and act as a yoke. The latter approach includes the fact that particular secondary coils S1, S2 do not necessarily have to be connected to bearing ring 2; 3, on which toroidal coil P1; P2 belonging to particular secondary coil S1, S2 is rotatably fixedly situated.

Only for the sake of completeness, let it be noted that, in connection with this application, the terms toroidal coil P, secondary coil S and/or coils P, S are understood to be a continuous winding of a wire running around rotation axis R. This annular design of the coils used according to the present invention is therefore also advantageous because, when using a plurality of segments 15 for each circular ring disk 8.1, 8.2, 9.1, 9.2, this type of coil does not require these segments 15 to be designed as individual segments—as is otherwise common practice in resolvers—to ensure a magnetic separation, but rather, according to the present invention, they may be also be designed as one-piece components which have a corresponding toothing only in the circumferential direction.

To further simplify manufacturing and assembly, in FIG. 1, circular ring disk 9.1 has also been connected to the unit of the two coils P1, S2, which interacts magnetically with the two circular ring disks 9.1, 9.2, before being inserted into annular space 7.

It is furthermore apparent from FIG. 1 that secondary coils S1, S2 are connected to evaluation electronics 12 via discharge lines 11. As discussed above in connection with toroidal coils P1, P2, the contacting of secondary coils S1, S2 is also particularly easy, because secondary coils S1, S2 in the exemplary embodiment illustrated in FIG. 1 are also connected to stationary bearing ring 3.

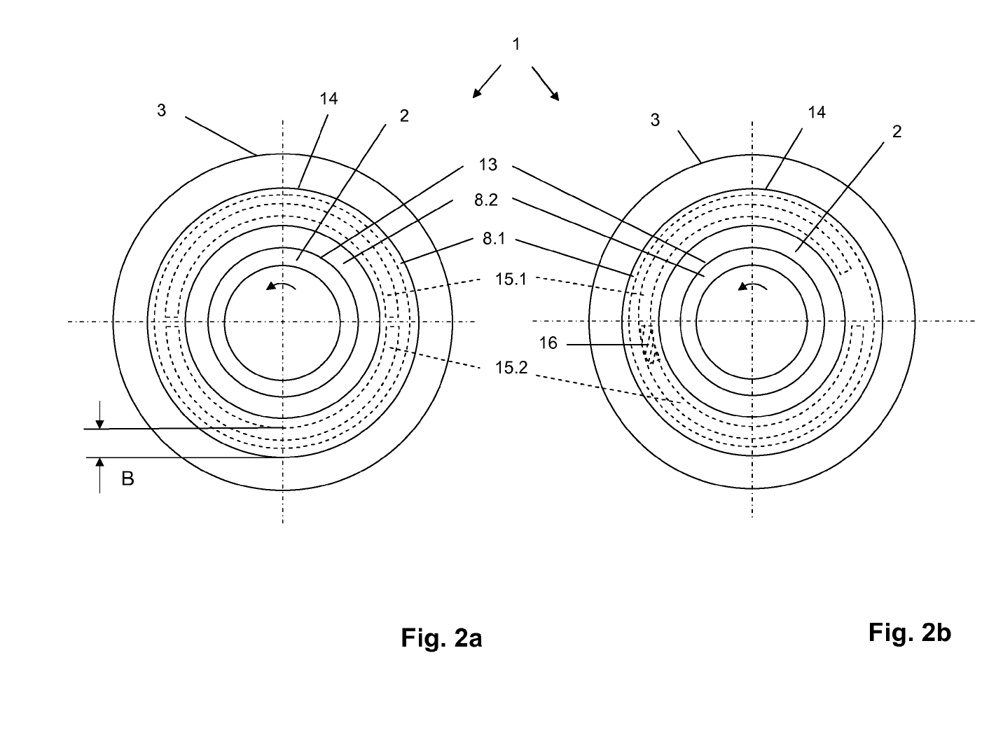

A side view of a resolver bearing 1 according to FIG. 1 is illustrated in FIGS. 2a and 2b. The structure of resolver bearing 1 is clearly apparent in this representation, whose subject is a view of seal 8. Circular ring disk 8.2 is mounted on outer circumference 13 of inner ring 2, while inner circumference 14 of outer ring 3 is connected to circular ring disk 8.1. Since circular ring disk 8.2 extends almost to outer ring 3, or circular ring disk 8.1 extends to inner ring 2, viewed toward seal 8 according to FIG. 1, area B discussed above sets in, in which circular ring disk 8.1 overlaps circular ring disk 8.2.

Each of circular ring disks 8.1, 8.2, 9.1 and 9.2 is essentially made of plastic and has a segment 15 in its interior, which is made of a material having a high permeability. In one simple exemplary embodiment, these segments may be stamped from a sheet and be inserted and injection molded in a corresponding injection molding die to form a circular ring disk 8.1, 8.2, 9.1 and/or 9.2.

Only for the sake of completeness, let it be noted that the term segment 15 also includes so-called sheet sections, slotted sheets, perforated sheets or impellers, which are situated evenly distributed in the circumferential direction of circular ring disks 8.1, 8.2, 9.1, 9.2, which are essentially made of plastic and which are magnetically conductively connected to particular bearing ring 2, 3.

In the exemplary embodiment illustrated in FIGS. 2a and 2b, the two circular ring disks 8.1 and 8.2 are each provided with only one segment 15.1, 15.2, each of these segments 15.1, 15.2 describing a toroid having an opening angle of 180°. The positions of the two segments 15.1, 15.2 in the two circular ring disks 8.1, 8.2 of seal 8 are coordinated with respect to each other in such a way that the two segments 15.1, 15.2 are able to overlap each other when the two bearing rings 2, 3 or circular ring disks 8.1, 8.2 are offset with respect to each other. If inner ring 2 is set into rotation according to the arrow direction while outer ring 3 is stationary, based on FIG. 2a, in which the two segments 15.1, 15.2 do not overlap each other, situations set in, which are illustrated in FIG. 2b. It is clearly apparent from the representation according to FIG. 2b that, when inner ring 2 rotates with respect to outer ring 3 by approximately 20°, both segments 15.1, 15.2 form an overlap area 16 of approximately 20°, which is provided with a hatching to better illustrate the situations. As inner ring 2 continues to rotate with respect to outer ring 3, a point is reached at which both segments 15.1, 15.2 overlap each other completely, and from which, providing the rotation continues, the overlap decreases again, until situations set in, which are illustrated in FIG. 2a.

Although FIG. 1 shows a resolver bearing 1, whose annular space 7 is closed against the environment with the aid of two seals 8, 9, which modulate the magnetic fields generated by toroidal coils P1, P2, in another exemplary embodiment—which is not illustrated—only one seal 8 or 9 modulating magnetic circuit M1 or M2 may be provided, while the other side of annular space 7 may be closed with the aid of a conventional seal, i.e., one which has no influence on the magnetic flux. In this case, the direction of rotation is not detected, so that a design of this type may be used, for example, as a rotational speed sensor.

If toroidal coil P1 according to FIG. 1 is energized, a magnetic circuit M1 forms around toroidal coil P1, in that the magnetic field lines use the slight magnetic resistances in outer ring 3, rolling bodies 4, in inner ring 2 and in segments 15.1, 15.2 to form a magnetic circuit M1. Since circular ring disks 8.1, 8.2 of seal 8 are rotatable with respect to each other, and overlap area 16 of the two segments 15.1, 15.2 changes with the mutual rotation, the magnetic flux through circular ring disks 8.1, 8.2 also changes. In other words, the rotation of segments 15.1, 15.2 with respect to each other acts on the magnetic flux in particular magnetic circuits M1, M2 like a modulator. As is easily apparent, in circular ring disks 8.1, 8.2 or 9.1, 9.2, each of which includes only one segment 15 having a high magnetic permeability, a minimum and a maximum are generated in the magnetic flux through resolver bearing 1 for each rotation of inner ring 2 with respect to outer ring 3, intermediate values also setting in between the maximum and the minimum or between the minimum and the maximum. The flux changes which arise with each rotation may be detected by secondary coil S2 and used, for example, to ascertain the rotational speed or angular position of inner ring 2 with respect to outer ring 3, using evaluation electronics 12.

Particularly exact statements on the angular positions of inner ring 2 and outer ring 3 may be made if, in addition to the so-called sinusoidal signal, a cosinusoidal signal is also generated. This is implemented in the exemplary embodiment in FIG. 1 by the fact that seal 9, like seal 8, is also formed by two circular ring disks 9.1, 9.2, and each of these circular ring disks 9.1, 9.2 is provided with a segment 15.1, 15.2 of the type already explained in connection with seal 8. However, to generate the cosinusoidal signal, segments 15.1, 15.2 on circular ring disks 9.1, 9.2 must be situated offset by 90° with respect to those on circular ring disks 8.1, 8.2. This offset by 90° causes a flux maximum, which arises, for example, due to the interaction of circular ring disks 8.1, 8.2, to coincide with a zero crossing on other seal 9.

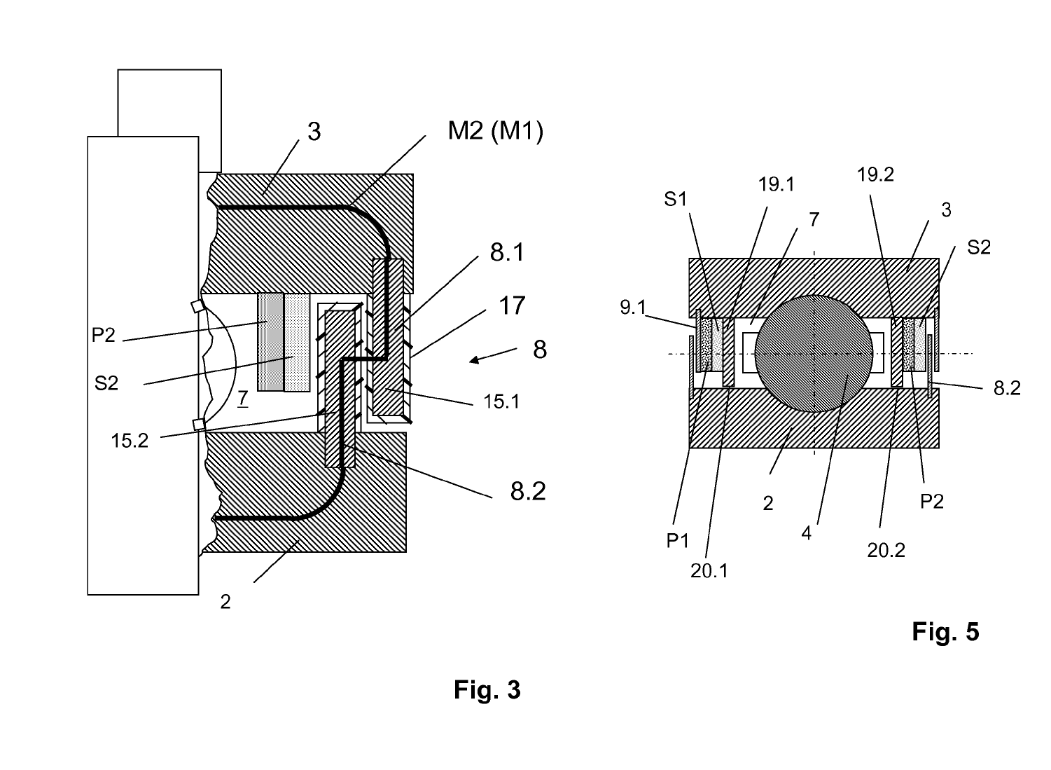

A particularly good magnetic circuit M1, (M2) forms when, in contrast to the representations according to FIGS. 2a and 2b, segments 15.1, 15.2 are guided into bearing rings 2, 3. Such a guidance of segments 15.1, 15.2 into bearing rings 2, 3 is illustrated in FIG. 3. It is also apparent in FIG. 3 that segments 15.1, 15.2 are covered by a thin layer 17 of plastic material, which incidentally also fills the gaps between segments 15 of a circular ring disk 8.1, 8.2 in the circumferential direction and which therefore contributes to forming circular ring disks 8.1, 8.2. If magnetically necessary, the plastic material may also be limited to the gaps between segments 15, so that segments 15 remain uncoated. Even if seal 8 in the exemplary embodiment illustrated in FIG. 3 is the only seal which modulates the magnetic flux through resolver bearing 1 and which seals annular space 7 against the environment, other seal 8 may, of course, close the axially opposite side of resolver bearing 1 against the environment, either using a conventional seal not sealing the magnetic flux or—as shown in FIG. 1—using a magnetically active seal 9.

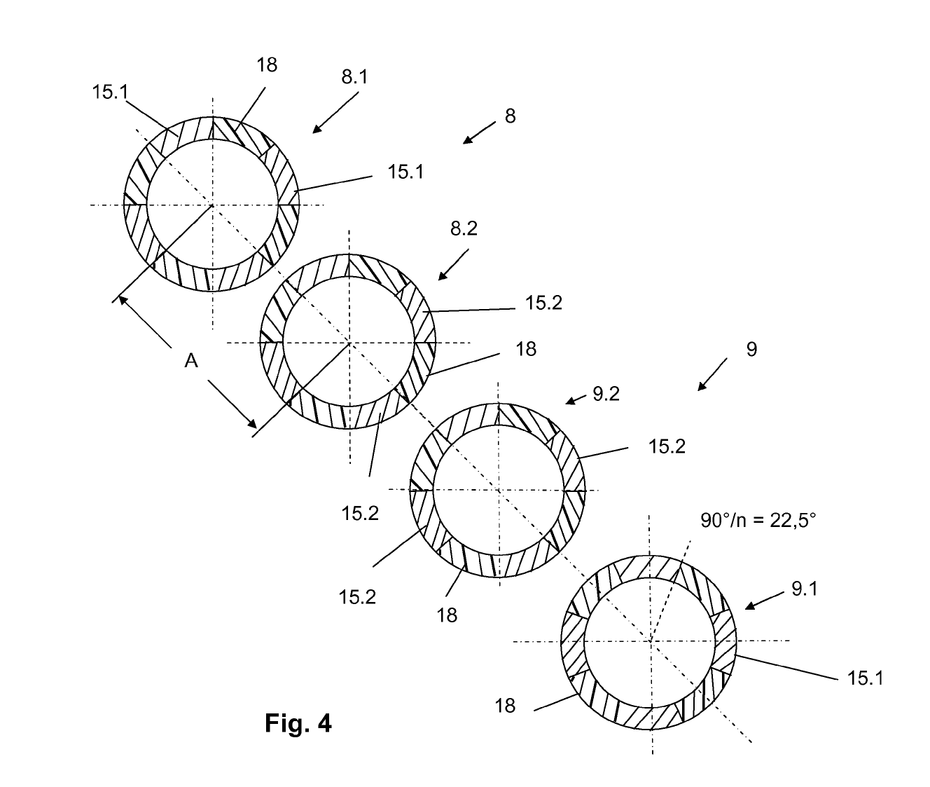

FIG. 4 shows two circular ring disks 8.1, 8.2 forming a seal 8, whose air gap A is illustrated enlarged in the axial direction for the sake of better illustration. Circular ring disk 8.1 illustrated therein is formed by four segments 15.1, made of a material which has a high permeability, and four areas 18, which are made of plastic, segments 15.1 and areas 18 alternating in the circumferential direction of these circular ring disks 8.1. The structure of circular ring disk 8.2 corresponds to that of circular ring disk 8.1. This correspondence between the two circular ring disks 8.1 and 8.2 also encompasses the number and size of segments 15.1, 15.2 and areas 18. This increase in the number of segments 15.1, 15.2 per circular ring disk 8.1, 8.2 causes the fact that a corresponding increase in frequency is maintained during each rotation of the one circular ring disk 8.1 with respect to the other circular ring disk 8.2 at the same amplitude of the signal, whereby the accuracy of resolver bearing 1 is increased over a resolver bearing which has only one segment 15.1, 15.2 per circular ring disk 8,1, 8.2.

To generate a cosinusoidal signal, seal 8 according to FIG. 4 is combined with another seal 9, which, like seal 8, is formed by two circular ring disks 9.1, 9.2. Each of these circular ring disks 9.1, 9.2 forming seal 9 also includes four segments 15.1, 15.2, made of a magnetically permeable material, which are separated in the circumferential direction of circular ring disks 9.1, 9.2 by areas 18 made of plastic. To form the cosinusoidal signal, the two circular ring disks 8.2, 9.2 are rotatably fixedly connected to particular rotating bearing ring 2 (not illustrated in FIG. 4), segments 15.2 and areas 18 of both circular ring disks 8.2, 9.2 being situated opposite each other in the direction of rotation axis R. Segments 15.1 and areas 18 of the two circular ring disks 8.1, 9.1, which are connected to stationary bearing ring 3 (not illustrated in FIG. 4), i.e., segments 15.1 of circular ring disk 9.1 are situated offset with respect to segments 15.1 of circular ring disk 8.1 by 90°/the number of segments per circular ring disk=22.5°, in view of the four segments 15.1 in each of the two circular ring disks 8.1, 9.1 so that each segment 15.1 of circular ring disk 8.1 covers half of a segment 15.1 and an area 18 of circular ring disk 9.1, viewed in the direction of rotation axis R.

In contrast to the design according to FIG. 1, in FIG. 5, the magnetic circuits generated by toroidal coils P1 and P2 (not illustrated in FIG. 5) are not closed under the action of rolling bodies 4, because rolling bodies 4 are made of a ceramic. Two toroidal short circuit sheets 19.1, 19.2, made of a magnetically permeable material, are therefore provided, which close particular magnetic circuits M1, M2 (only indicated in FIG. 5) and which are situated next to rolling bodies 4 in the axial direction. In the exemplary embodiment illustrated in FIG. 5, these short circuit sheets 19.1, 19.2 are rotatably fixedly connected to outer ring 3 and form an additional sealing gap 20.1, 20.2 with regard to inner ring 2. As discussed above in connection with FIG. 1, short circuit sheet 19.1 (19.2), toroidal coil P1 (P2), secondary coil S1 (S2) and circular ring disk 9.1 (8.2) were connected before being inserted into annular space 7 between the two bearing rings 2, 3 in connection with FIG. 5, for the purpose of simplifying assembly. Only for the sake of completeness, let it be noted that these short circuit sheets 19.1, 19.2 may be used even if rolling bodies 4 are made of a magnetically permeable material, but it must be feared that lubricant present in tracks 5.1, 5.2 (FIG. 1) of rings 2, 3 will at least temporarily impair the magnetic closure.

### LIST OF REFERENCE NUMERALS

1 resolver bearing
2 inner ring
3 outer ring
4 rolling body
5.1, 5.2 tracks
6 cage
7 annular space
8 seal
8.1, 8.2 circular ring disk, seal 8
9 seal
9.1, 9.2 circular ring disk, seal 9
10 connecting line
11 discharge line
12 evaluation electronics
13 outer circumference
14 inner circumference
15.1, 15.2 segment
16 overlap area
17 layer
18 areas
19.1, 19.2 short circuit sheets
20.1, 20.2 sealing gap

1-8. (canceled)

9. A resolver bearing comprising:
an inner ring;
an outer ring;
rolling bodies rolling on tracks provided on the inner and outer rings in the annular space formed between the inner and outer rings;
a circular ring disk rotatably fixedly connected to one of the inner and outer rings for the purpose of sealing the annular space and extending radially in the direction of the other of the inner and outer rings;
a primary coil;
at least one secondary coil; and
the inner and outer rings and a component provided between the rings are made of a magnetically permeable material;
the circular ring disk being situated next to another circular ring disk at an axial distance, the other circular ring disk being rotatably fixedly connected to the other of the inner and outer rings and extending radially in the direction of the one the inner and outer rings;
each of the circular ring disk and other circular ring disk including at least one segment made of a magnetically permeable material; and
the primary and secondary coils in the annular space between the circular ring disk and the other circular ring disk and the component being rotatably fixedly connected to the inner or outer ring.

10. The resolver bearing as recited in claim 9 wherein the component provided between the inner and outer rings are the rolling bodies or at least one short circuit sheet.

11. The resolver bearing as recited in claim 10 wherein the annular space between the rings is completely sealed against the environment by the circular ring disk and the other circular ring disk, in that, in addition to the circular ring disk and the other circular ring disk, two additional circular ring disks, situated at a slight distance from each other, are provided, each of the additional circular ring disks being rotatably fixedly connected to one of the inner and outer rings and extending radially in the direction of the other of the inner and outer rings.

12. The resolver bearing as recited in claim 11 wherein each of the additional circular ring disks is also provided with at least one segment made of a magnetically permeable material; the segments of the additional circular ring disks being offset with respect to each other by an angle of 90°/n, n corresponding to the number of segments per circular ring disk, while, in this position of the segments of the additional circular ring disk, the segments of the other circular ring disks are not offset by an angle with respect to each other; and further comprising an additional toroidal coil and an additional secondary coil in the annular space between the two additional circular ring disks and the rolling bodies or a short circuit sheet rotatably fixedly connected to the inner and outer rings.

13. The resolver bearing as recited in claim 9 wherein the primary and secondary coils are each connected to a stationary ring of the inner and outer rings.

14. The resolver bearing as recited in claim 9 wherein the circular ring disk and the other circular ring disk each includes a plurality of segments situated evenly distributed in the circumferential direction of the circular ring disk and the other circular ring disk.

15. The resolver bearing as recited in claim 9 wherein the circular ring disk and the other circular ring disk are made of a material which has no or minimal magnetic permeability; and the segments are situated embedded in the circular ring disk and the other circular ring disk.

16. The resolver bearing as recited in claim 9 wherein either one of the primary and secondary coils or a unit of the primary and secondary coils connected with the modulation action of the circular ring disk and other circular ring disk form one structural unit together with one of the circular ring disk and the other ring disk, in that the one circular ring disk or other circular ring disk is mounted and connected laterally to the one of the primary and secondary coils or the unit; and the one structural unit is inserted as such into the annular space and is rotatably fixedly connected to the one of the inner and outer rings.
